(19) United States
(12) Patent Application Publication
(10) Pub. No.: US 2012/0263567 A1
(43) Pub. Date: Oct. 18, 2012

(54) METHOD AND APPARATUS FOR ORIENTATING BOTTLES

(75) Inventors: Etienne Le Roux, Paarl (ZA); Alexander Le Roux, Paarl (ZA)

(73) Assignee: Etienne Le Roux, Paarl (ZA)

(21) Appl. No.: 13/502,857

(22) PCT Filed: Oct. 19, 2010
(86) PCT No.: PCT/IB2010/054720

§ 371 Date: Jun. 29, 2012

(30) Foreign Application Priority Data
Oct. 19, 2009 (ZA) 2009/07275

(51) Int. Cl. B65G 47/14

(52) U.S. Cl. 414/754; 414/816

(57) ABSTRACT

A method and apparatus are provided for configuring equipment (10) for automated orientation of elongate objects (56). The equipment includes a drum (12) with a cylindrical circumferential wall (14) and a central raised element (22) inside the drum, that slopes towards the circumferential wall, the outer edges of the raised element being spaced radially inwardly from the circumferential wall. The method includes sliding a plurality of sector elements (34) in a radial direction so that a trough (52) is defined between the circumferential wall of the drum and an outer edge of each sector element, the width of said trough corresponding generally to the width of the objects sought to be orientated.

### FIELD OF THE INVENTION

This invention relates to configuring equipment for automated orientation of elongate objects such as bottles, of different sizes, and while the invention has application in other industries, it is intended particularly for automated bottle filling in a so-called “bottle unscrambler”.

### BACKGROUND TO THE INVENTION

When containers are supplied to automated handing machines, e.g. when bottles are supplied to bottle filling machines, they need to be orientated correctly to be received by the machines. The orientation of bottles can be done in variety of different ways, but one of the techniques is to discharge the bottles with random orientations into a large cylindrical drum with a bottom that is sloped towards an appropriately sized trough along its lower circumference. The trough has a width that is just wide enough to receive a bottle longitudinally in the trough and the bottom of the drum is rotated so that centrifugal forces cause bottles to enter the trough with a longitudinal orientation, i.e. aligned with the trough. Bottles that lie longitudinally in the trough are collected in a suitable receiver, from where they are fed to conveyors that lead them to the bottle handling equipment, e.g. bottle filling equipment.

After the bottles have been collected in the receiver, they can have one of two orientations, with their openings either facing forwards or backwards and they are rectified to face in the same direction before being fed to the bottling machines, etc., but the rectification is not important for the purposes of the present invention.

A drum such as that described above, with a raised central part and a trough around its inner circumference is referred to in the art as a “bottle unscrambler”.

In plants where more than one size, shape or configuration of bottle needs to be filled, it is possible to use different unscramblers for each different version of bottle, but it is more cost-effective to use the same unscrambler drum and the drive mechanism for different bottles, but to replace some components (referred to as “change parts” in the art) of the unscrambler to accommodate different bottles. In particular, unscramblers are available with change parts in the form of different sized domes/cones that fit inside the drum, to provide different widths of circumferential troughs between the outer circumference of the dome/cone and the circumferential wall of the drum.

When bottle unscramblers need to be changed for handling different sized bottles, the change parts inside the drum need to be removed and this is typically done by releasing fasteners such as nuts or bolts. The sizeable and heavy parts then need to be removed from the drum and the replacements fitted. This process is cumbersome and labour intensive and causes a loss of productivity as the unscrambler is unavailable for service while the change is made.

The present invention seeks to provide for quick, easy and convenient changing of bottle unscramblers between configurations for different bottle sizes, thereby to minimise machine down-time. The invention is described in relation to bottle unscramblers, but it can be used in many other types of automated equipment used to unscrambler randomly oriented articles that have a generally cylindrical or other elongate shape.

### SUMMARY OF THE INVENTION

According to a first aspect of the present invention there is provided a method of configuring equipment for automated orientation of elongate objects, said equipment including a drum with a cylindrical circumferential wall and a central raised element inside the drum, that slopes towards the circumferential wall, the outer edges of the raised element being spaced radially inwardly from the circumferential wall; wherein said method comprises sliding a plurality of sector elements in a radial direction so that a trough is defined between the circumferential wall of the drum and an outer edge of each sector element, the width of said trough corresponding generally to the width of the objects sought to be orientated.

By “corresponding generally” is meant that the elongate objects to be orientated can be received in the trough with sufficient clearance to be removed from the trough in an automated manner.

The method may include simultaneously sliding a plurality of the sector elements in a radial direction and the radial sliding may be actuated by exerting a radial force, i.e. pushing or puling each sector element with an elongate element such as a rod or linkage, e.g. to slide it along a radial rail.

The plurality of sector elements may be slid radially by rotating a central disc to which inner ends of each linkage is attached.

The method may include receiving a circumferential protuberance of each sector element in a complemental circumferential recess defined on the adjacent sector element, so that the circumferential elements overlap along their common circumference.

According to another aspect of the present invention there is provided apparatus for automated orientation of elongate objects, said apparatus comprising:
a drum with a cylindrical circumferential wall;
a central raised element inside the drum, that slopes towards the circumferential wall, the outer edges of the raised element being spaced radially inwardly from the circumferential wall;
a plurality of sector elements, each disposed at least partly below the central raised element so that a trough is defined between the outer edge of the sector elements and the circumferential wall, and each sector element being configured to slide in a radial direction to adjust the width of the trough to corresponding generally to the width of the objects sought to be orientated in the apparatus; and
an adjustment mechanism, configured to slide the sector element in the radial direction.

The adjustment mechanism may include a radial rail along which the sector element can slide and can include a rod or linkage that is configured to actuate the sector element by pushing or pulling it along the rail. The rod/linkage may be pushed or pulled by rotating an actuator such as a central disc to which an inner end of the rod/linkage is attached and a plurality of such rods/linkages may be attached to the disc, to actuate the plurality of the sector elements simultaneously.

Each sector element may have a circumferential protuberance on one side and a complemental recess on an opposing side, so that the protuberance of one sector element is received in the recess of the adjacent element and the circumferential elements thus overlap along their common circumference.

### BRIEF DESCRIPTION OF THE DRAWINGS

For a better understanding of the present invention, and to show how the same may be carried into effect, the invention will now be described by way of non-limiting example, with reference to the accompanying drawings in which:

FIG. 1 is a three-dimensional view of a bottle unscrambler in accordance with the present invention, with some ancillary equipment;

FIG. 2 is a sectional view of the bottle unscrambler of FIG. 1;

FIG. 3 is a three-dimensional view of parts of the bottle unscrambler of FIG. 1, showing inter alia, an adjustment mechanism and adjustable sector elements;

FIGS. 4 and 5 are top plan views of the adjustment mechanism and sector elements of FIG. 3—in a fully retracted position in FIG. 4 and in a fully extended position in FIG. 5;

FIG. 6 is a top three-dimensional view of a sector element of the bottle unscrambler of FIG. 1; and

FIG. 7 is a bottom three-dimensional view of the sector element of FIG. 6.

### DETAILED DESCRIPTION OF THE DRAWINGS

Referring to the drawings, apparatus for automated orientation of elongate objects in the form of bottles, i.e. a bottle unscrambler in accordance with the present invention is generally indicated by reference numeral 10.

The bottle unscrambler 10 includes a cylindrical drum 12 that has a cylindrical outer, peripheral wall 14. Inside the drum 12, a rotating assembly 16 is supported on a central, upright shaft 18 that is driven by a motor and gearbox 20. The rotating assembly 16 includes a central raised element in the form of a hollow cone 22 and two circular flanges: an upper flange 24 that extends radially outwardly from the circumference of the cone 22, but that is spaced inwardly of the circumferential wall 14; and a lower flange 26 that is spaced below the upper flange and with an outer circumference that extends much closer to the circumferential wall. The cone 22 and flanges 24,26 generally remain fixed to the shaft 18 during use of the unscrambler.

The unscrambler also has an adjustment mechanism 28 which includes ten radial spokes 30, each with a square cross-sectional profile, that are fixedly mounted to a bottom disc 32, to rotate with the shaft 18. On the outer end of each spoke 30, there is a sector element 34 in the form of a generally sector-shaped horizontal plate with a groove 36 on its underside, that is complementally shaped to the spoke and in which the spoke is received in a sliding manner. Each sector element 34 also defines two slots 38 that are aligned with the groove 36 and through which it is connected to the spoke 30 with fasteners such as bolts 40, to keep the sector element in position, with the spoke 30 received in the groove 36, while the sector element slides radially along the spoke, with the spoke acting as a rail for the sector element.

Each sector element 34 has a curved outer edge 42 and defines a lateral protuberance 44 on its one side and a complementally shaped recess 46 on its opposite side, so that the protuberance of one sector element can slide into the recess of the adjacent sector element, with the outer edges of the sector elements generally aligned to form a common circumference of the sector elements and with the protuberances 44 received in the recesses 46 causing the sector elements to overlap, when viewed from above or below.

The adjustment mechanism 28 further includes an upper disc 48 that extends above the spokes 30 and that can rotate relative to the shaft 18. Ten rods or linkages 50 each have an inner end pivotally connected to the upper disc 48, along circumferentially spaced pivot points and the outer end of each linkage 50 is pivotally attached to a sector element at a position above the groove 36.

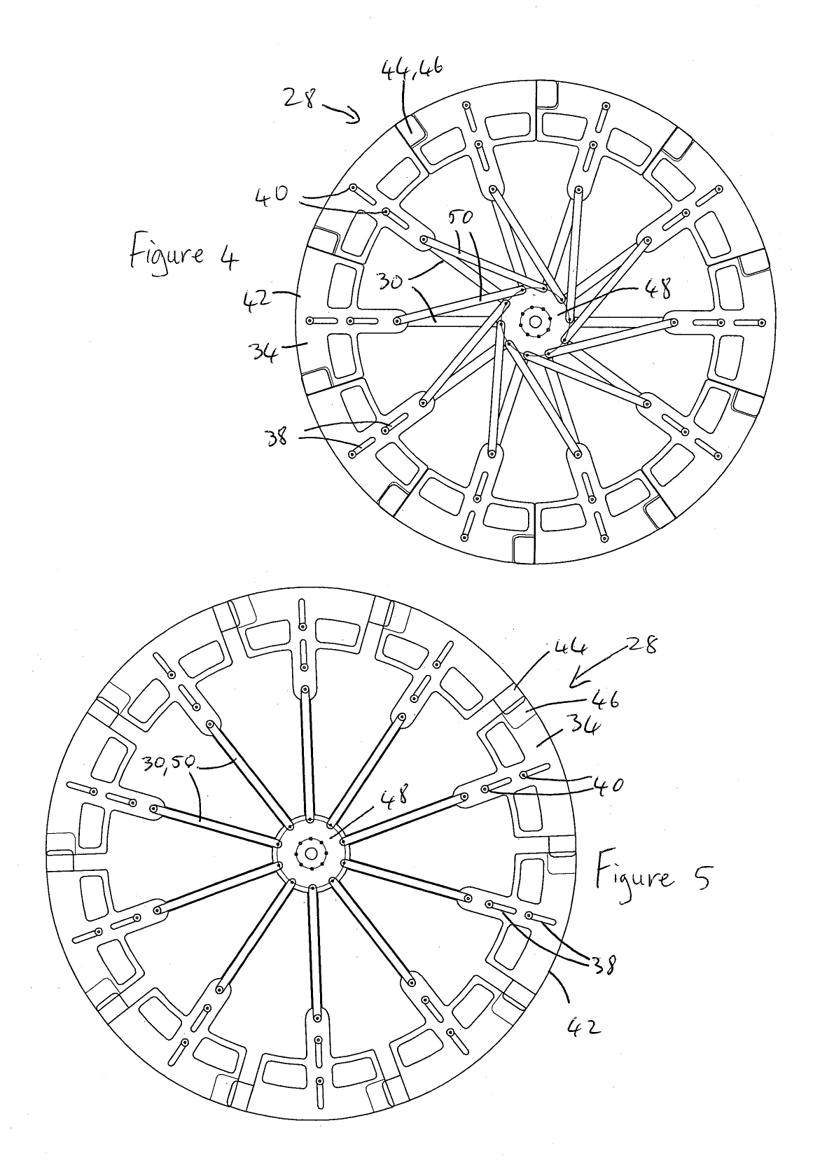

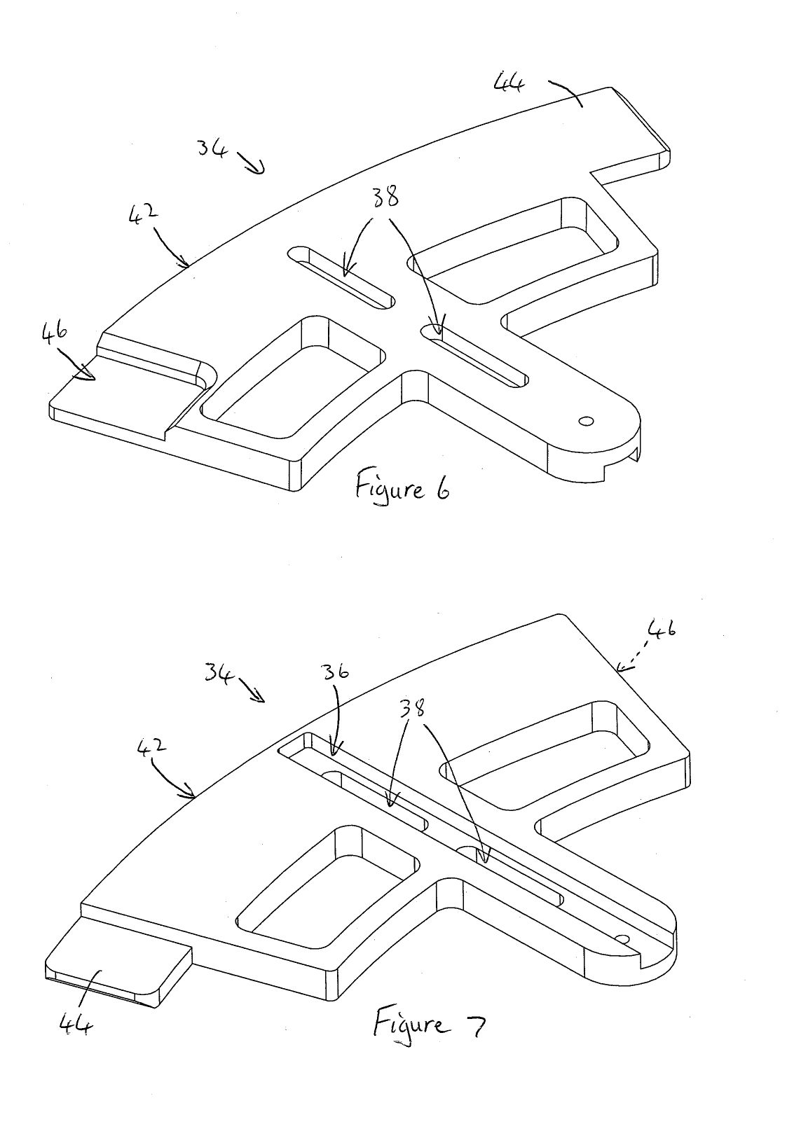

A circumferential trough 52 is defined above the lower flange 26, between the circumferential wall 14 and the outer edges 42 of the sector elements 34. In order to adjust the width of the trough 52, the upper disc 48 is rotated relative to the shaft 18, by twisting a handle 54. The rotation of the upper disc 48 causes the inner end of each linkage 50 to be moved closer to or farther from the spoke 30 that is associated with the same sector element 34 as the particular linkage. If the linkage 50 is aligned with the spoke 30, the sector element 34 is in an extended position, in which the common circumference formed by the outer edges 42 is the largest, as shown in FIG. 5. If the inner end of the linkage 50 is rotated with the upper disc 48 so that the linkage extends at an angle relative to its associated spoke 30, the outer end of the linkage is caused to draw the sector element 34 to slide radially inward along the spoke and likewise, rotation of the upper disc in the opposite direction will cause the linkage to come into closer alignment with the spoke and to push the sector element radially outwards. In FIG. 4, each sector elements 34 is shown in a retracted position, in which the common circumference formed by the outer edges 42 is the smallest. As the common circumference of the outer edges 42 varies, so the width of the trough 52 varies.

As the sector elements 34 are slid radially inwards and outwards along their respective spokes 30 and the common circumference of their outer edges 42 varies, the protuberances 44 slide in and out of the recesses 46 of the adjacent sector elements, in a circumferential direction. In the retracted position of the sector elements 34 (FIG. 4), each protuberance 44 extends deep into its associated recess 46 and the lateral edges of the sector elements abut, so that the sector elements form a generally solid, continuous flange and the trough 52 is at its widest. In the extended position of the sector elements 34 (FIG. 5), there are spaces between adjacent sector elements, but the protuberances 44 still extend partly into their associated recesses 46, so that the sector elements effectively “overlap” by way of the engagement of the protuberances and recesses and the sector elements thus still form a continuous flange, with the trough 52 at its widest.

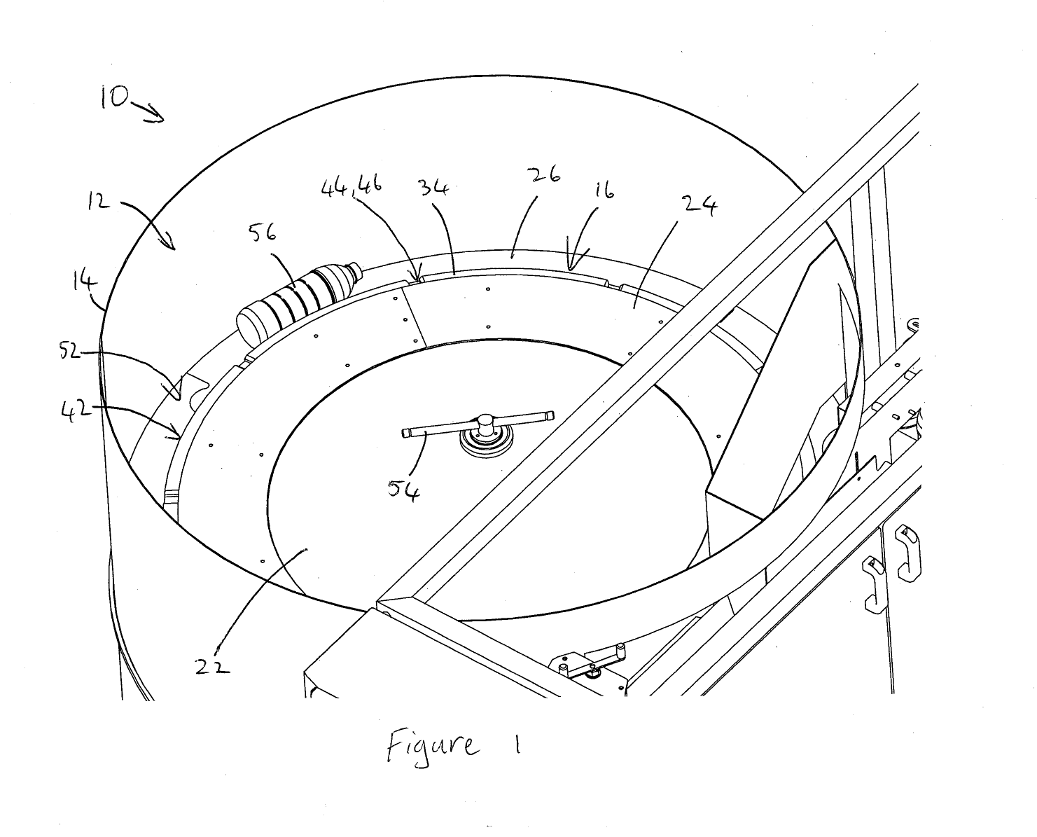

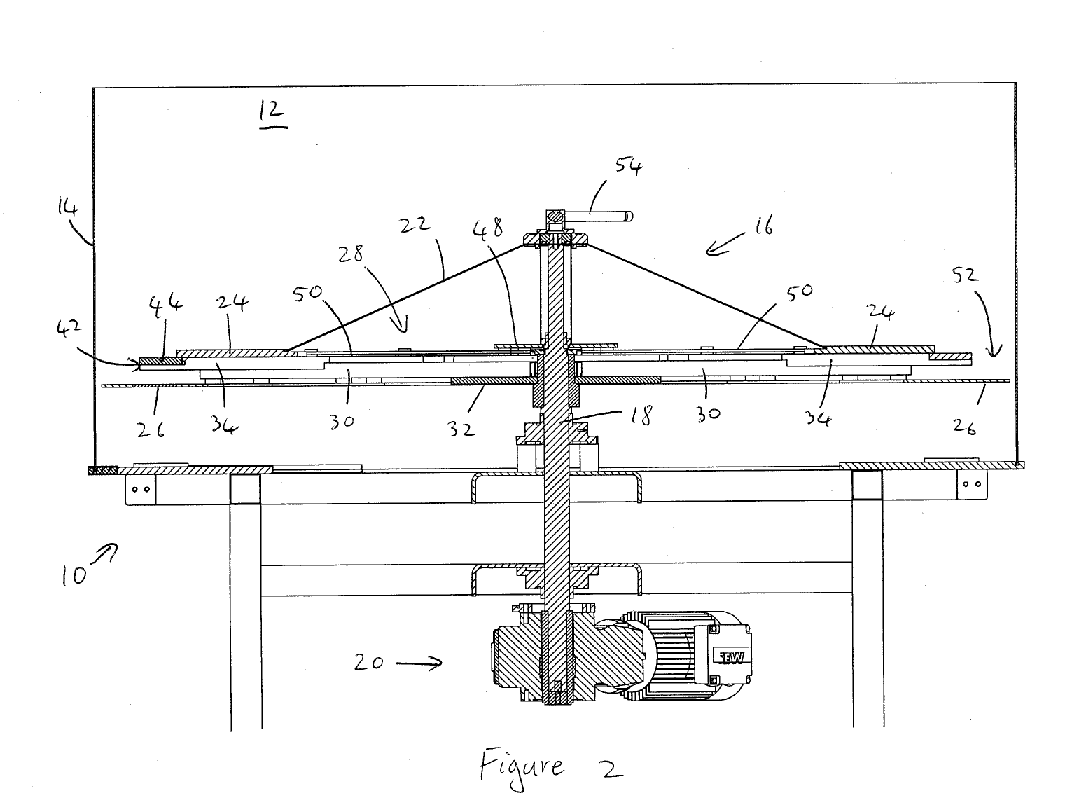

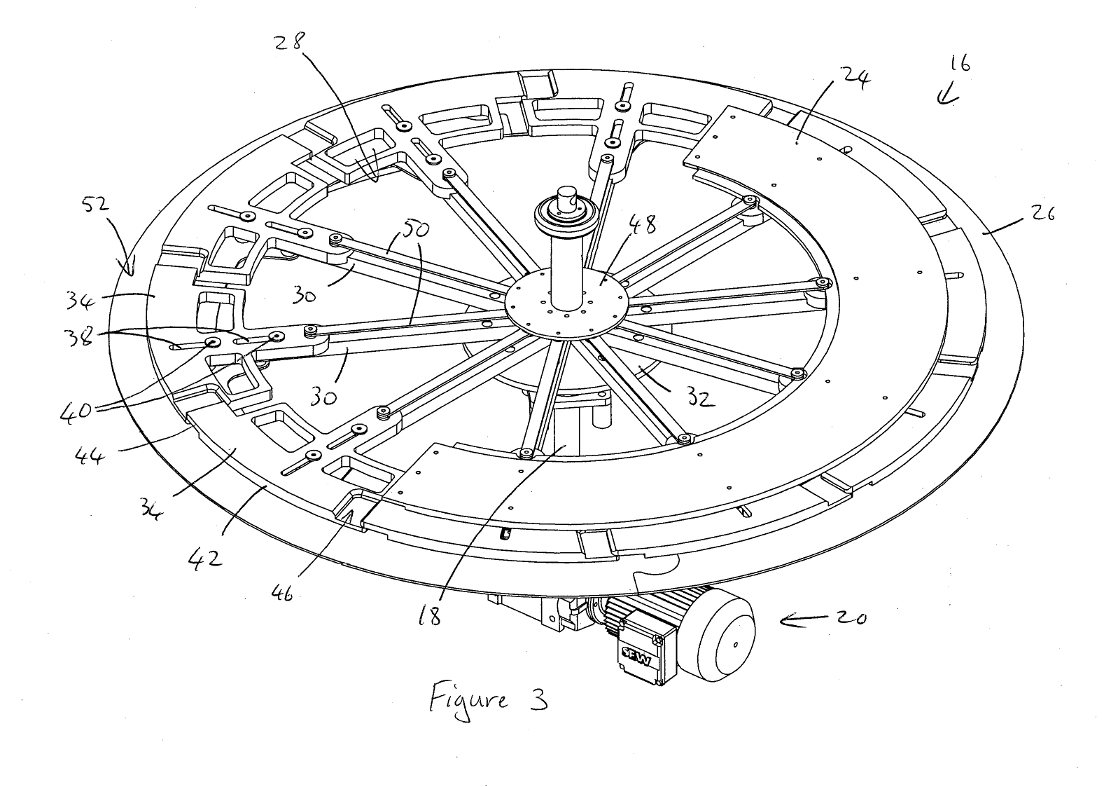

In use, the handle 54 is twisted to adjust the sector elements 34 radially inwardly or outwardly as described herein above, until the trough 52 has a width that is suitable for the particular bottles that are sought to be unscrambled. (An example of a bottle 56 in the groove 52 is shown in FIG. 1.) The handle 54 is then locked in position and the unscrambler 10 is used in the normal way, by rotating the entire rotating assembly 16 together. If bottles 60 of a different size need to be unscrambled, the handle 54 is unlocked and is twisted relative to the shaft 18 to adjust the width of the trough 52 again, as described above, the handle is locked and the unscrambler 10 is used in the normal way, but on different sized bottles.

1-11. (canceled)

12. A method of configuring equipment for automated orientation of elongate objects, said equipment including a drum with a cylindrical circumferential wall and a central raised element inside the drum, that slopes towards the circumferential wall, the outer edges of the raised element being spaced radially inwardly from the circumferential wall; said method including sliding a plurality of sector elements in a radial direction such that a trough is defined between the circumferential wall of the drum and an outer edge of each sector element, the width of said trough corresponding generally to the width of the objects sought to be orientated.

13. A method according to claim 12, which includes simultaneously sliding a plurality of said sector elements in a radial direction.

14. A method according to claim 13, which includes actuating said radial sliding of the sector elements by exerting a radial force on each sector element with an elongate element.

15. A method according to claim 14, which includes sliding said sector elements radially by rotating a central disc to which inner ends of each elongate element are attached.

16. A method according to claim 12, which includes receiving a circumferential protuberance of each sector element in a complemental circumferential recess defined on the adjacent sector element.

17. A method according to claim 14, which includes receiving a circumferential protuberance of each sector element in a complemental circumferential recess defined on the adjacent sector element.

18. Apparatus for automated orientation of elongate objects, said apparatus comprising:
a drum with a cylindrical circumferential wall;
a central raised element inside the drum, that slopes towards the circumferential wall, the outer edges of the raised element being spaced radially inwardly from the circumferential wall;
a plurality of sector elements, each disposed at least partly below the central raised element so that a trough is defined between the outer edge of the sector elements and the circumferential wall, and each sector element being configured to slide in a radial direction to adjust the width of the trough to correspond generally to the width of the elongate objects sought to be orientated in the apparatus; and
an adjustment mechanism, configured to slide the sector elements in the radial direction.

19. Apparatus according to claim 18, wherein said adjustment mechanism includes a radial rail along which the sector element can slide.

20. Apparatus according to claim 18, wherein said adjustment mechanism includes an elongate element that is configured to actuate the sector element by exerting a radial force on the sector element.

21. Apparatus according to claim 20, wherein said radial force is exerted on said elongate element by rotating an actuator to which an inner end of the elongate element is attached

22. Apparatus according to claim 21, wherein a plurality of said elongate elements are attached to the actuator, to actuate the plurality of the sector elements simultaneously.

23. Apparatus according to claim 18, wherein each of said sector elements has a circumferential protuberance on one side and a complemental recess on an opposing side, said protuberance and recess being configured such that the protuberance of one sector element is receivable in the recess of the adjacent sector element, at least in part.

24. Apparatus according to claim 20, wherein each of said sector elements has a circumferential protuberance on one side and a complemental recess on an opposing side, said protuberance and recess being configured such that the protuberance of one sector element is receivable in the recess of the adjacent sector element, at least in part.

25. Apparatus according to claim 22, wherein each of said sector elements has a circumferential protuberance on one side and a complemental recess on an opposing side, said protuberance and recess being configured such that the protuberance of one sector element is receivable in the recess of the adjacent sector element, at least in part.
